(19) United States
(12) Patent Application Publication
(10) Pub. No.: US 2009/0185335 A1
(43) Pub. Date: Jul. 23, 2009

(54) MODULE TYPE POWER DISTRIBUTION APPARATUS

(76) Inventor: Yeong Min Kwon, Gyeonggi-do (KR)

Correspondence Address: HARNESS, DICKEY, & PIERCE, P.L.C, 7700 Bonhomme, Suite 400, ST. LOUIS, MO, 63105, US

(21) Appl. No.: 12/307,606

(22) PCT Filed: Jun. 22, 2007
(86) PCT No.: PCT/KR07/03036

§ 371 Date: Jan. 6, 2009

(30) Foreign Application Priority Data
Jul. 6, 2006 (KR) 20-2006-0018317

(51) Int. Cl. H02B 1/04

(52) U.S. Cl. 361/643

(57) ABSTRACT

The present invention provides a module type power distribution apparatus in which power sources of an electrical distribution board and a switchboard for industry and home can be separated and the module type power distribution apparatus can be simply connected to the distribution board and the switchboard by bolts through modularization. Thus, simple detachment and attachment are possible without complicated fabrication processes as in the prior art and productivity can be improved through standardization. Further, the module type power distribution apparatus can be fabricated by a person having ordinary skill only by attaching or detaching a line breaker and can be reused. Furthermore, current depending on the usage of electricity can be detected through a current transformer and displayed on a display unit and the flow of current through an output terminal can be supplied to the outside. Incidentally, when fabricating a distribution board and a switchboard for industry, booth bars can be obviated and simply modularized in an airtight state. Accordingly, accidents, such as electric shock, ground and shortcircuit, and the leakage of poisonous gases upon fire, which occur due to booth bars and an acrylic cover, can be prevented.

### TECHNICAL FIELD

The present invention relates, in general to a module type power distribution apparatus, and more particularly, to a module type power distribution apparatus in which power sources of an electrical distribution board and a switchboard for industry and home can be separated, which can be connected to the distribution board and the switchboard simply by bolts through modularization and detachably mounted simply without complicated fabrication processes as in the prior art, thus improving productivity through standardization, which can be fabricated by a person having ordinary skill only by attaching or detaching a line breaker to enable reuse, and in which current depending on the usage of electricity can be detected through a current transformer to thereby be displayed on a display unit, the flow of current through an output terminal can be supplied to the outside, and booth bars can be obviated when fabricating the distribution board and the switchboard for industry and can be simply modularized in an airtight state, thus preventing accidents, such as electric shock, ground and shortcircuit, and the leakage of poisonous gases upon fire, which occur due to booth bars and an acrylic cover.

### BACKGROUND ART

In general, in order to separate power sources of an electrical distribution board and a switchboard for industry and home, a variety of breakers, such as a main breaker, a branch breaker and a leakage current circuit breaker, are needed. Thus, there are problems in that it is technically difficult to fabricate the distribution board and the switchboard and a special apparatus called a booth bar processing machine is required.

Further, the power sources of the electrical distribution board and the switchboard are generally separated. The power sources are connected to a bus by booth bars and then attached to the breaker. Complicated fabrication processes, such as hole machining, tap machining, rounding machining, coating, tube bending and cutting, are performed on the booth bar. Thus, excessive cost and a special equipment booth bar processing machine are required, and the time limit is delayed accordingly.

Further, in the case where the distribution board and the switchboard are dismantled, reuse is impossible because components are not standardized and the components cannot be also disused. In addition, iron material must be used as a protection cover in order to protect a charging unit. Thus, the charging unit is simply covered with an acrylic cover, which has no difficulty in fabrication. In this case, however, there are problems in that poisonous gases are generated from acrylic upon fire, and electric shock accidents, shortcircuit accidents and ground accidents occur due to foreign substance upon check or replacement of the breaker since the charging unit is exposed.

### DISCLOSURE OF INVENTION

### Technical Problem

Accordingly, the present invention has been made in an effort to solve the above problems occurring in the prior art, and an object of the present invention is to provide a module type power distribution apparatus in which power sources of an electrical distribution board and a switchboard for industry and home can be separated and which can be simply connected to the distribution board and the switchboard by bolts through modularization, so that simple detachment and attachment are possible without complicated fabrication processes as in the prior art and productivity can be improved through standardization.

Another object of the present invention is to provide a module type power distribution apparatus that can be fabricated by a person having ordinary skill only by attaching or detaching a line breaker and can be reused.

Still another object of the present invention is to provide a module type power distribution apparatus in which current depending on the usage of electricity can be detected through a current transformer and displayed on a display unit, and the flow of current through an output terminal can be supplied to the outside. Further another object of the present invention is to provide a module type power distribution apparatus in which booth bars can be obviated when fabricating a distribution board and a switchboard for industry and can be simply modularized in an airtight state, thus preventing accidents, such as electric shock, ground and shortcircuit, and the leakage of poisonous gases upon fire, which occur due to booth bars and an acrylic cover.

### Technical Solution

To accomplish the above objects, according to an embodiment of the present invention, there is provided a module type power distribution apparatus, including a plurality of main breaker terminals disposed on a top surface of a casing and connected to a main breaker power source by means of lines; a plurality of branch breaker terminals disposed on both sides of the casing and connected to a branch breaker power source by means of the lines; and a plurality of additional terminals disposed on a lower side of the casing and connected to other external load terminals or additional branch lines, wherein a surface of the casing is depressed. The casing protects the branch lines of the power sources connected to the main breaker terminals, the branch breaker terminals and the additional terminals.

According to another embodiment of the present invention, there is provided a module type power distribution apparatus, including a module type power distribution apparatus, including a plurality of main breaker terminals disposed on a top surface of a casing and connected to a main breaker power source by means of lines; a plurality of branch breaker terminals disposed on both sides of the casing and connected to a branch breaker power source by means of the lines; a plurality of additional terminals disposed on a lower side of the casing and connected to other external load terminals or additional branch lines, wherein a surface of the casing is depressed; a current transformer for detecting amperage of the power sources supplied to the main breaker terminals and the branch breaker terminals, which are connected by means of the lines, within the casing; an A/D converter for converting analog data, that is, current data detected by the current transformer, into digital data; and a display unit for displaying data, converted by the A/D converter, on a surface of the casing. The casing protects branch lines of the power sources connected to the main breaker terminals, the branch breaker terminals and the additional terminals.

In the present invention, the lines interconnecting the main breaker terminals and the branch breaker terminals may be connected in parallel.

In the present invention, the main breaker terminals, the branch breaker terminals and the additional terminals may be fixedly interconnected in such a manner as to be fastened by bolts.

### ADVANTAGEOUS EFFECTS

As described above, the present invention provides a module type power distribution apparatus in which power sources of an electrical distribution board and a switchboard for industry and home can be separated and the module type power distribution apparatus can be simply connected to the distribution board and the switchboard by bolts through modularization. Thus, simple detachment and attachment are possible without complicated fabrication processes as in the prior art and productivity can be improved through standardization. Further, the module type power distribution apparatus can be fabricated by a person having ordinary skill only by attaching or detaching a line breaker and can be reused. Furthermore, current depending on the usage of electricity can be detected through a current transformer and displayed on a display unit and the flow of current through an output terminal can be supplied to the outside. Incidentally, when fabricating a distribution board and a switchboard for industry, booth bars can be obviated and simply modularized in an airtight state. Accordingly, accidents, such as electric shock, ground and shortcircuit, and the leakage of poisonous gases upon fire, which occur due to booth bars and an acrylic cover, can be prevented.

### BRIEF DESCRIPTION OF THE DRAWINGS

Further objects and advantages of the invention can be more fully understood from the following detailed description taken in conjunction with the accompanying drawings in which:

FIG. 1 illustrates a module type power distribution apparatus according to an embodiment of the present invention;

FIG. 2 illustrates the module type power distribution apparatus including a display unit for displaying detected amperage according to an embodiment of the present invention;

FIG. 3 is a front view of the module type power distribution apparatus according to an embodiment of the present invention;

FIG. 4 is a circuit diagram implementing the module type power distribution apparatus according to an embodiment of the present invention;

FIG. 5 is a perspective view of the module type power distribution apparatus according to an embodiment of the present invention;

FIG. 6 illustrates that the module type power distribution apparatus according to an embodiment of the present invention is assembled with a main breaker and a branch breaker;

FIG. 7 is a front view of the module type power distribution apparatus according to an embodiment of the present invention, which is assembled with the main breaker and the branch breaker; and

FIG. 8 is a view illustrating a state where the module type power distribution apparatus according to an embodiment of the present invention is connected to a household distribution box for home.

### MODE FOR THE INVENTION

The present invention will now be described in detail in connection with specific embodiments with reference to the accompanying drawings. In describing the present invention, in the case where detailed description of related known techniques or construction is determined to make unnecessarily unclear the gist of the present invention, detailed description thereof will be omitted. Terms to be described later on are ones defined in consideration of functions in the present invention. They may vary depending on users, the intention of an operator, customs or the like. Such definition should be based on contents covering the present specification to describe the module type power distribution apparatus of the present invention.

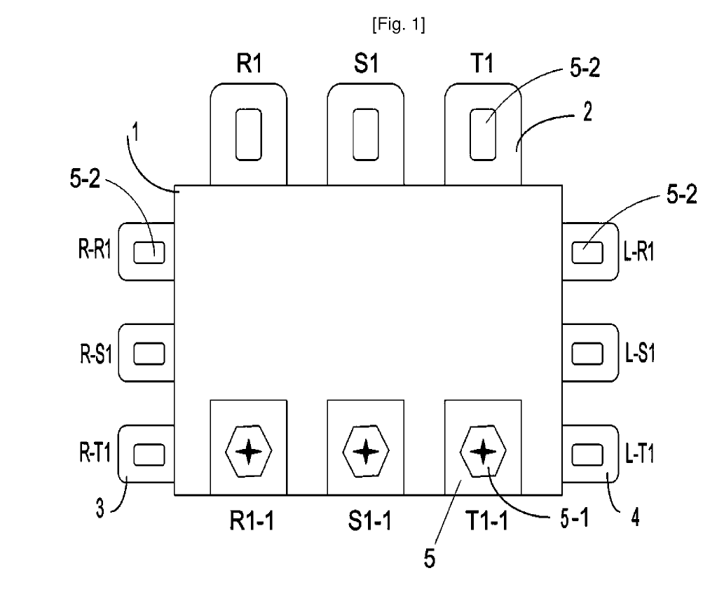

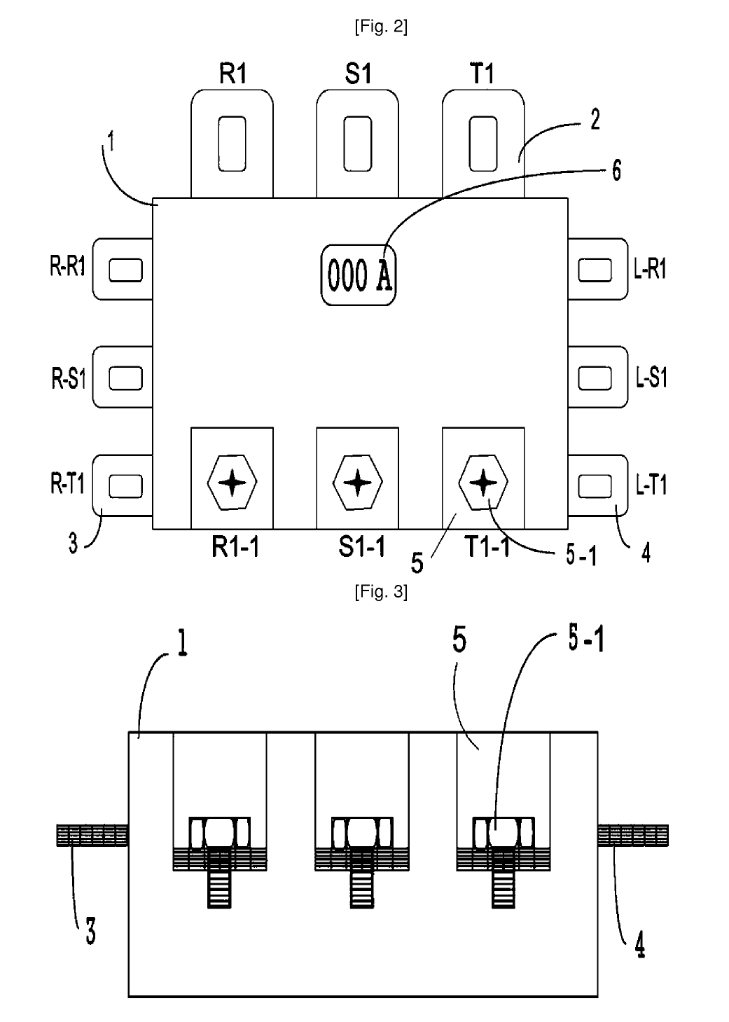

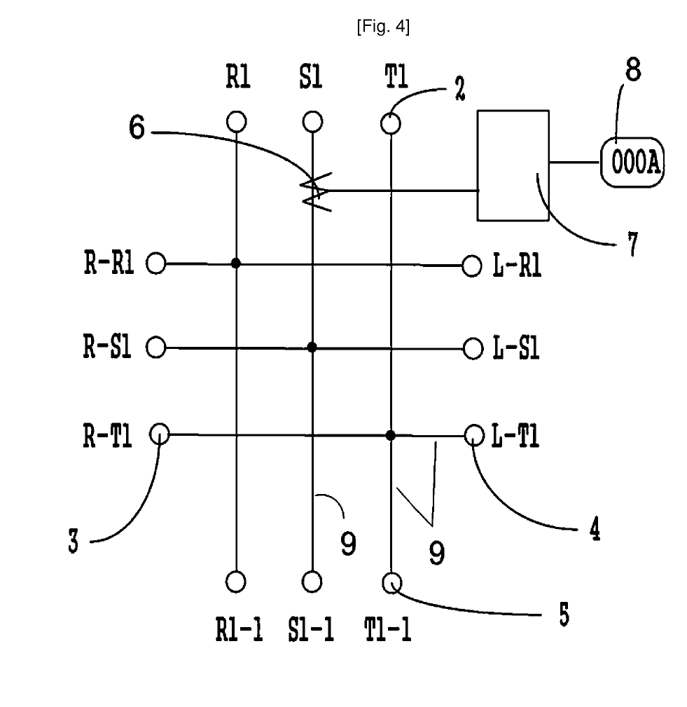

FIG. 1 illustrates a module type power distribution apparatus according to an embodiment of the present invention. FIG. 2 illustrates the module type power distribution apparatus including a display unit for displaying detected amperage according to an embodiment of the present invention. FIG. 3 is a front view of the module type power distribution apparatus according to an embodiment of the present invention. FIG. 4 is a circuit diagram implementing the module type power distribution apparatus according to an embodiment of the present invention.

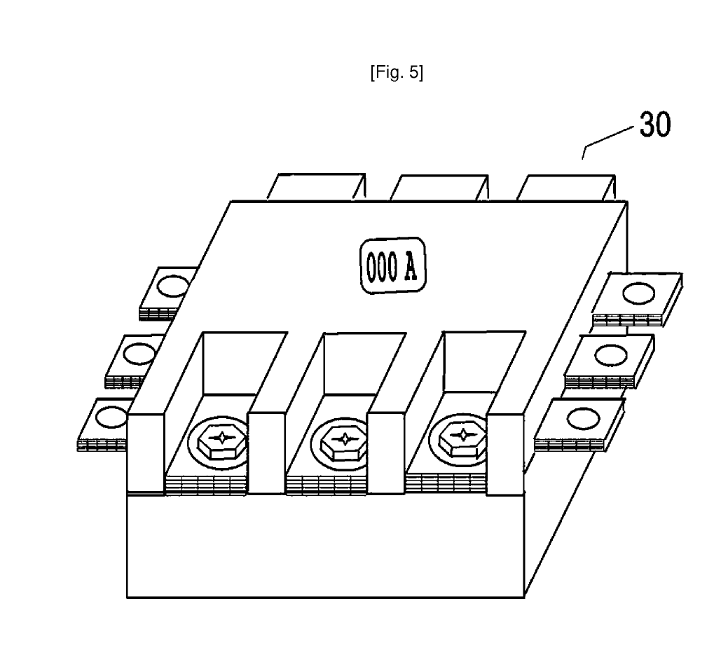

As shown in FIGS. 1 to 5, a module type power distribution apparatus 30 according to an embodiment of the present invention includes a casing 1, main breaker terminals 2, branch breaker terminals 3, 4, additional terminals 5, bolts 5-1, a current transformer 6, an A/D converter 7, a display unit 8, lines 9 and so on.

The functions of respective technical means constituting the module type power distribution apparatus are described below.

The casing 1 serves to protect the branch lines 9 of a power source connected to the main breaker terminals 2 and the branch breaker terminals 3, 4 and the additional terminals 5, and is made of fire-retardant insulating material.

The main breaker terminals 2 are disposed on the top surface of the casing 1 and are connected to a main breaker power source by means of the lines. The number of the main breaker terminals 2 is plural.

The branch breaker terminals 3, 4 are disposed on both sides of the casing 1 and connected to a branch breaker power source by means of the lines. The number of the branch breaker terminals 3, 4 is plural.

The additional terminals 5 are disposed on the lower side of the casing 1. The additional terminals 5 can be connected to other external load terminals or additional branch lines since the surface of the casing is depressed. The number of the additional terminals 5 is also plural. The main breaker terminals 2, the branch breaker terminals 3, 4 and the additional terminals 5 have screw grooves formed therein.

The current transformer 6 serves to detect amperage of the power source supplied to the main breaker terminals 2 and the branch breaker terminals 3, 4, which are connected by means of the lines 9, within the casing 1. The core of the current transformer can be formed from one of nano grain alloy, amorphous alloy, ferrite, and metal core.

The A/D converter 7 serves to convert analog data, that is, current data, which is detected through the current transformer 6, into digital data. It has been described that the A/D converter 7 is used. However, the A/D converter 7 can be replaced with a D/A converter depending on the type of data.

The display unit 8 serves to display data, converted by the A/D converter 7, on the surface of the casing.

It has been described that the module type power distribution apparatus 30 has three main breaker terminals. However, the number of the main breaker terminals can be two or four, or can be changed, if appropriate.

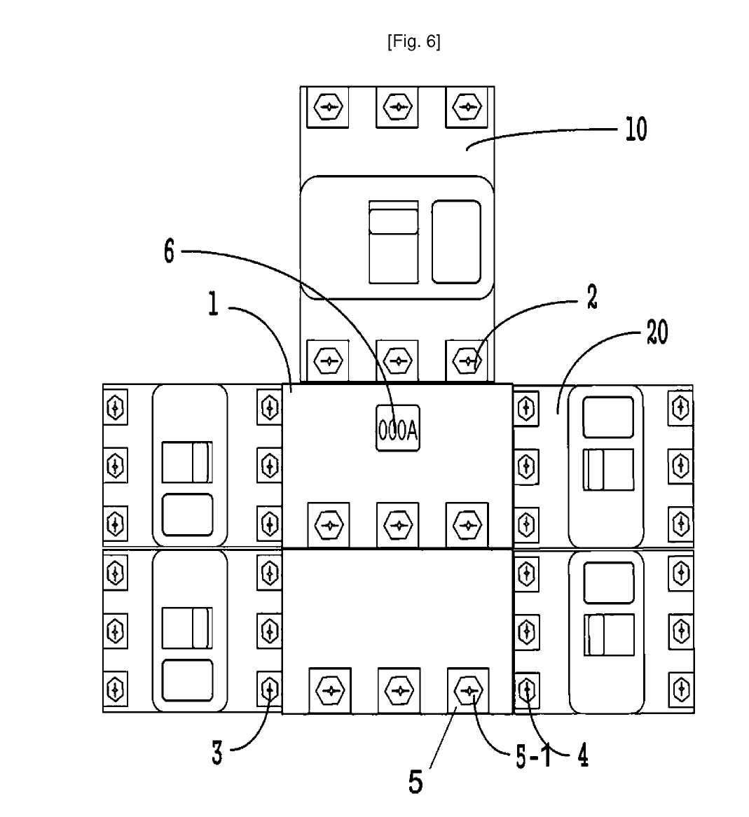

Referring to FIGS. 4 and 6, upper terminals R1, S1 and T1, that is, the main breaker terminals 2 of the present invention are stacked on the bottoms R, S and T of a main breaker 10, respectively. The upper terminal R1, S1 and T1 supply power to lower terminals R1-1, S1-1 and T1-1, respectively, through the lines 9. The upper terminal R1, S1 and T1 also supply power to the branch breaker terminals 3 R-R1, R-S1 and R-T1 on the left side and the branch breaker terminals 4 L-R1, L-S1 and L-T1 on the right side, respectively, through the lines 9. The flow of the current is detected through the current transformer 6. Analog data, that is, current data detected in the current transformer 6 is converted into digital data through the A/D converter 7 and then displayed on the display unit 8. The lines 9 are bent.

Referring to FIGS. 1 to 5, screw grooves 5-2 are formed in the terminals R1, S1, T1, R-R1, R-S1, R-T1, L-R1, L-S1 and L-T1, respectively, so that they can be easily assembled after releasing the breaker bolts. The lower terminals R1-1, S1-1 and T1-1 are implemented using bolts so that they can be easily extended. In this circuit configuration, A R phase consists of one circuit so that R phase power can be supplied to terminals R-R1, L-R1 and R1-1 through the terminal R1 via the lines 9. An S phase consists of one circuit so that S phase power can be supplied to terminals R-S1, L-S1 and S1-1 through the terminal S1 via the lines 9. A T phase consists of one circuit so that T phase power can be supplied to terminals R-T1, L-T1 and T1-1 via the lines 9.

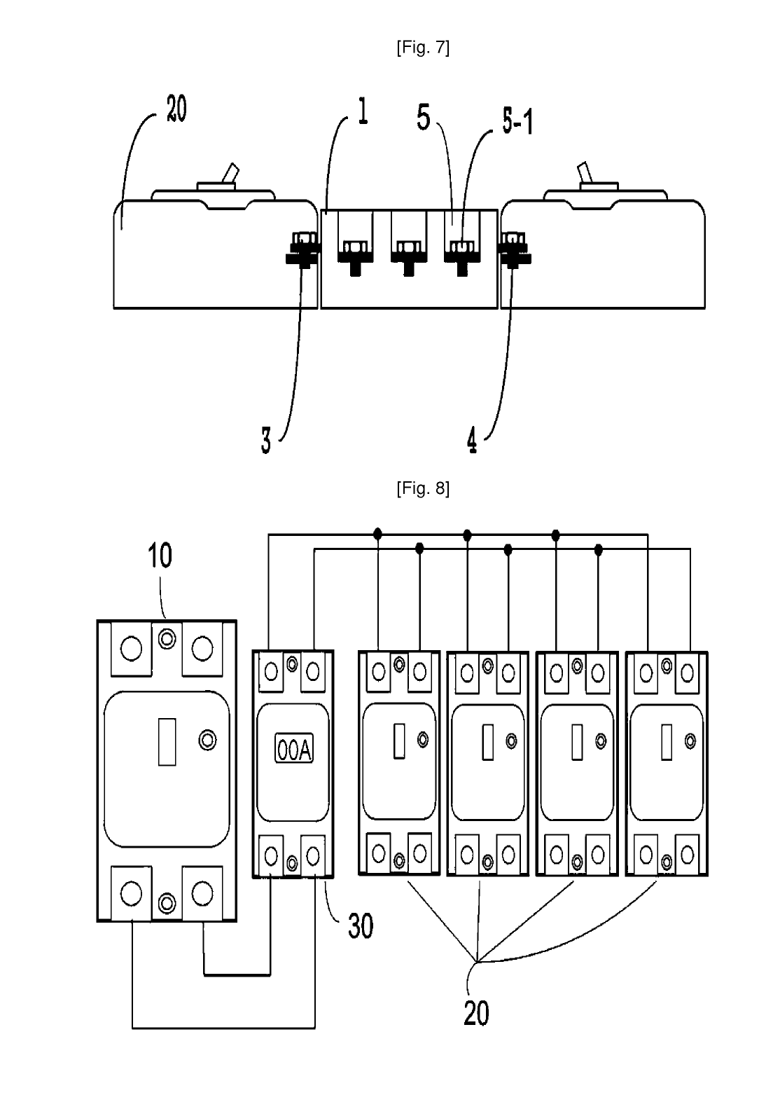

FIG. 6 illustrates that the module type power distribution apparatus according to an embodiment of the present invention is assembled with a main breaker and a branch breaker. FIG. 7 is a front view of the module type power distribution apparatus according to an embodiment of the present invention, which is assembled with the main breaker and the branch breaker. FIG. 8 is a view illustrating a state where the module type power distribution apparatus according to an embodiment of the present invention is connected to a household distribution box for home.

FIGS. 6 and 7 illustrate plan and front views of a state where the module type power distribution apparatus 30 is connected to the main breaker 10 and a branch breaker 20. A user can easily fix them by the bolts 5-1. Pins other fixing member can also be used instead of the bolts. Further, as can be seen from a state where the module type power distribution apparatus 30 is connected to a household distribution box for home as shown in FIG. 8, the module type power distribution apparatus 30 can be connected to one main breaker 10 and a plurality of the branch breakers 20.

The external shape of the above module type power distribution apparatus is only illustrative. When module type power distribution apparatuses have the same construction and operation, those skilled in the art can modify and change the external shape of the leakage current circuit breaker. Thus, the present invention is not limited to the above embodiment and the accompanying drawings.

### INDUSTRIAL APPLICABILITY

As described above, the present invention provides a module type power distribution apparatus in which power sources of an electrical distribution board and a switchboard for industry and home can be separated and the module type power distribution apparatus can be simply connected to the distribution board and the switchboard by bolts through modularization. Thus, simple detachment and attachment are possible without complicated fabrication processes as in the prior art and productivity can be improved through standardization. Further, the module type power distribution apparatus can be fabricated by a person having ordinary skill only by attaching or detaching a line breaker and can be reused. Furthermore, current depending on the usage of electricity can be detected through a current transformer and displayed on a display unit and the flow of current through an output terminal can be supplied to the outside. Incidentally, when fabricating a distribution board and a switchboard for industry, booth bars can be obviated and simply modularized in an airtight state. Accordingly, accidents, such as electric shock, ground and shortcircuit, and the leakage of poisonous gases upon fire, which occur due to booth bars and an acrylic cover, can be prevented.

1. A module type power distribution apparatus, comprising:
a plurality of main breaker terminals disposed on a top surface of a casing and connected to a main breaker power source by means of lines;
a plurality of branch breaker terminals disposed on both sides of the casing and connected to a branch breaker power source by means of the lines; and
a plurality of additional terminals disposed on a lower side of the casing and connected to other external load terminals or additional branch lines, wherein a surface of the casing is depressed,
wherein the casing protects the branch lines of the power sources connected to the main breaker terminals, the branch breaker terminals and the additional terminals.

2. A module type power distribution apparatus, comprising:
a plurality of main breaker terminals disposed on a top surface of a casing and connected to a main breaker power source by means of lines;
a plurality of branch breaker terminals disposed on both sides of the casing and connected to a branch breaker power source by means of the lines;
a plurality of additional terminals disposed on a lower side of the casing and connected to other external load terminals or additional branch lines, wherein a surface of the casing is depressed;
a current transformer for detecting amperage of the power sources supplied to the main breaker terminals and the branch breaker terminals which are connected by means of the lines, within the casing;
an A/D converter for converting analog data, that is, current data detected by the current transformer, into digital data; and
a display unit for displaying data, converted by the A/D converter, on a surface of the casing,
wherein the casing protects branch lines of the power sources connected to the main breaker terminals, the branch breaker terminals and the additional terminals.

3. The module type power distribution apparatus of claim 1, wherein the lines interconnecting the main breaker terminals and the branch breaker terminals are connected in parallel.

4. The module type power distribution apparatus of claim 1, wherein the main breaker terminals, the branch breaker terminals and the additional terminals are fixedly interconnected in such a manner as to be fastened by bolts.

5. The module type power distribution apparatus of claim 2, wherein the lines interconnecting the main breaker terminals and the branch breaker terminals are connected in parallel.

6. The module type power distribution apparatus of claim 2, wherein the main breaker terminals, the branch breaker terminals and the additional terminals are fixedly interconnected in such a manner as to be fastened by bolts.
